(19) United States
(12) Patent Application Publication
(10) Pub. No.: US 2013/0333197 A1
(43) Pub. Date: Dec. 19, 2013

(54) DECORATIVE LIGHTING INSTALLATION SYSTEM AND METHOD

(71) Applicants: BRUCE SCHULTE, ESCONDIDO, CA (US); THOMAS MARTIN, SAN MARCOS, CA (US)

(72) Inventors: BRUCE SCHULTE, ESCONDIDO, CA (US); THOMAS MARTIN, SAN MARCOS, CA (US)

(21) Appl. No.: 13/917,214

(22) Filed: Jun. 13, 2013

Related U.S. Application Data
(60) Provisional application No. 61/659,436, filed on Jun. 14, 2012.
(60) Provisional application No. 61/734,465, filed on Dec. 7, 2012.

(51) Int. Cl. B25J 1/04; F16M 13/02; F21V 21/08

(52) U.S. Cl. CPC B25J 1/04; F21V 21/08; F16M 13/02
USPC 29/525.08; 294/211; 294/174

(57) ABSTRACT

A system for easy installation of the accessory on a building comprising a clip and an installation tool is disclosed. The clip can accept an accessory (e.g. a light string), and reversibly engages the tool. The tool can be conveniently mounted on a elongated handle so the user can work without ascending and descending a ladder. The clip comprises structures to secure it in the tool while the clip and accessory are being positioned. The clip is configured to the flexible and to provide a bias force that maintains the clip and accessory in position once installed on the building member. Once the clip is in the position, the tool can be disengaged from the clip and a new clip inserted in the tool. The invention for example is useful for easy lifting and placement of a string of decorative lights on a building facia or comparable structure.

This application claims the benefit under 35 U.S.C. §119(e) of U.S. Provisional Application No. 61/659,436, filed Jun. 14, 2012, and entitled “Decorative Lighting Installation System and Method”, and U.S. Provisional Application No. 61/734,465, filed Dec. 7, 2012, and entitled “Decorative Lighting Installation System and Method”, the entirety of which are hereby incorporated by reference.

### FIELD OF THE INVENTION

The field of the invention relates to devices and methods for installing and securing decorative lighting to structures, in particular to devices and methods for installing decorative lighting strings to the facia of a building.

### BACKGROUND

It is common practice to install decorative lighting on buildings at various times including for example during holiday seasons. Typical methods of installation involve placing hooks, nails or other devices onto or into the building surface, gutters, facia or other structural components of buildings onto which one desires to install lighting.

Hooks or like items that are intended to receive and maintain lighting strings in place are generally installed manually and require the installer to climb a ladder in order to access the location where the lights are to be installed. An additional limitation with using fasteners to secure lighting is that they inevitably damage the material to which they are attached. For example, nails and screws leave holes that adversely affect the appearance of a structure when the lights are removed. If left in place, these same fasteners can weather causing staining, again reducing the overall aesthetic appearance of the building.

Further, since lighting strings are usually installed laterally to decorate a building by following a architectural feature such as a roof-line, installing the hook or other device requires the installer to climb the ladder, install the hook or other securing means, descend the ladder, and then move the ladder to repeat the process. For installation of long light strings, this then requires significant effort and expenditure of time, as well as the risk of injury inherent in the use of ladders. As a result, a number of solutions have been attempted in order to address this problem.

For example, U.S. Pat. No. 8,083,276 (Schopp) discloses a plastic tool configured to engage a screw hook, which can then be screwed into an overhead structure. This device is limited in that it is only useful for installing screws into building surfaces, which may result in undesired damage, or in some cases may be impossible where the screw cannot penetrate the surface of the material onto which the lighting is intended to be installed.

U.S. Pat. No. 7,488,018 (Rommelmann, Jr.) discloses a bracket that is designed to fit over a gutter on a building. However, this invention provides no easy method of installation and thus requires that a user climb up and down a ladder in order to mount the bracket on the building.

U.S. Pat. No. 7,429,067 (Rosa) discloses a mounting device that includes a specialized hook structure designed to engage a light string. However, the disclosure does not provide a description of a convenient way in which to mount a hook or other securing device on the building onto which the light string will be secured.

U.S. Pat. No. 6,827,379 (Hill et al.) discloses a system of gutter clips and a tool for their installation. However, the invention is strictly limited to use with rain gutters and cannot be adapted for use with other building structures such as facia. Further, once installed, the clips of the '379 invention are not easily removable.

U.S. Pat. No. 6,487,765 (Brekkam) discloses a U-shaped took designed to hold onto the wiring of a light string while the string is lifted into place to engage a previously installed screw hook mounted on a building. This device requires that hooks, or other structures that the light string is being secured to, be already in place on the building.

U.S. Pat. No. 6,425,614 (Limber et al.) discloses a tool comprising a spool onto which a string of lights are mounted. The string can be fed out as the light string is being mounted. However, this invention still does not address the problem of the prior placement of the structures to which the light string will be secured. U.S. Pat. No. 6,352,291 (Tortajada) discloses a similar concept, and suffers from similar limitations.

Similarly, U.S. Pat. No. 5,868,334 (Cedillo) discloses a tool for holding a spool of decorative lights on a pole for easier deployment, but again does not address the ultimate problem of how to place the structures onto which the lights are to eventually be hung.

Still others have described bracket systems for mounting decorative lighting, for example U.S. Pat. No. 5,065,747 (Kireta), but not an applicator tool with which to install the mounting bracket.

Thus, despite numerous attempts there still remains a need for a simple, easy to use system for mounting decorative lighting on buildings or other structures, and which does not requires the use of screws or other traditional fasteners, and which can be used on structures to which screws and other fasteners may be unsuitable.

### SUMMARY OF THE INVENTION

The present invention provides an apparatus designed to improve the ease of installing accessories on building structures, for example lighting strings on facia of buildings. The invention comprises a clip and installation tool. The clip is configured such that it can accept and maintain in place an accessory such as the electrical wiring of a lighting string. The clip is further designed to engage an installation tool. The tool can be conveniently mounted on a handle or other reach-extending device.

When engaged by the tool the clip and accessory can be lifted into place using the handle. Once in place the clip can be pushed upwards against the bottom edge of the facia, for example, in order to spread the clip and allow it to slide onto the building structure. The clip can be fashioned from a resilient flexible material such that it can bend to fit onto the structure onto which it is to be mounted. Once in place, the tendency of the clip to return to its original shape provides sufficient bias force to maintain the clip and wiring in the desired position on the building, without the need for any other fastening devices.

In some cases the clip can include friction surface on the inner aspect of the side portions. These serve to improve the grip of the clip on the building structure thus aiding in maintaining the clip in position.

The installation tool is configured such that once the clip is in place a simple twisting motion releases the clip from the tool. A new clip can then be inserted into the tool and according to the method described herein a user can progressively install an accessory such as a lighting string with relative ease. By providing a separate clip and tool, an advantage is obtained in ease of manufacture and more efficient use of material. Further, the clip can be configured to blend in with the building aesthetics better since there is no extraneous material, as is found in prior art devices.

Therefore, in some embodiments there is provided a system for installing an accessory on a structure, the system comprising a clip configured to be reversibly installable on a building member, the clip comprising a clip base portion and clip side portions, the clip side portions extending generally upwards from the clip base portion; wherein, when installed in a desired location, the clip side portions are configured to exert a bias force on the building member, such that the clip and the accessory will remain substantially in place until removed by a user; wherein at least one clip side portion comprises at least one installation tool engagement structure; an installation tool configured to reversibly engage the clip, the installation tool comprising a tool base portion from which extend tool side portions; wherein at least one tool side portion comprises a receiving structure configured to receive the at least one installation tool engagement structure on the at least one clip side portion; and wherein the installation tool further comprises a mounting point configured for mounting the installation tool on a reach-extending device.

In some embodiments, the clip further comprises a notch, the notch configured to receive the accessory.

In some embodiments, the installation tool engagement structure comprises a fin and the receiving structure comprises a groove.

In some embodiments, the clip further comprises at least one friction surface, the at least one friction surface effective to maintain the clip in place after installation in the desired location.

In some embodiments, a clip side portion further comprises a lower clip side portion and an upper clip side portion, wherein the lower clip side portion extends inwards, and the upper clip side portion extends outwards, relative to a central vertical axis of the clip.

In some embodiment, the clip further comprises side portion tips, the side portions tips spaced apart a distance greater than a width of the building member on which the clip is to be installed.

In some embodiments, the accessory to be installed on the structure is at least one of a lighting string, a banner, a flag and an electrical cord.

In some embodiments, the building member is at least one of a facia, gutter, and a rafter tail.

In some embodiments there is provide a method for installing an accessory on a structure, the method comprising: providing a clip configured to be reversibly installable on a building member, the clip comprising a clip base portion and clip side portions, the clip side portions extending generally upwards from the clip base portion; wherein, when installed in a desired location, the clip side portions are configured to exert a bias force on the building member, such that the clip and the accessory will remain substantially in place until removed by a user; wherein at least one clip side portion comprises at least one installation tool engagement structure; providing an installation tool configured to reversibly engage the clip, the installation tool comprising a tool base portion from which extend tool side portions; wherein at least one tool side portion comprises a receiving structure configured to receive the at least one installation tool engagement structure on the at least one clip side portion; and wherein the installation tool further comprises a mounting point configured for mounting the installation tool on a reach-extending device; providing a reach-extending device, and mounting the installation tool on said device; engaging the accessory in the clip; engaging the clip with accessory into the installation tool; placing the clip and accessory at a location on the building member; applying a generally vertical force to the reach-extending device sufficient to position the installation tool, clip and accessory into a desired position on the building member; once the clip and accessory are in the desired position, applied a generally rotational force to the reach-extending device, the rotational force effective to disengage the clip from the installation tool.

In some embodiments of the method, the clip further comprises a notch, the notch configured to receive the accessory.

In some embodiments of the method, the installation tool engagement structure comprises a fin and the receiving structure comprises a groove.

In some embodiments of the method, the clip further comprises at least one friction surface, the at least one friction surface effective to maintain the clip in place after installation in the desired location.

In some embodiments of the method, a clip side portion further comprises a lower clip side portion and an upper clip side portion, wherein the lower clip side portion extends inwards, and the upper clip side portion extends outwards, relative to a central vertical axis of the clip.

In some embodiments of the method, the clip further comprises side portion tips, the side portions tips spaced apart a distance greater than a width of the building member on which the clip is to be installed.

In some embodiments of the method, the accessory to be installed on the structure is at least one of a lighting string, a banner, a flag and an electrical cord.

In some embodiments of the method, the building member is at least one of a facia, gutter, and a rafter tail.

In some embodiment, there is provided a means for installing an accessory on a building member, the means comprising: a clip configured to be reversibly installable on a building member, the clip comprising a clip base portion and clip side portions, the clip side portions extending generally upwards from the clip base portion; wherein, when installed in a desired location, the clip side portions are configured to exert a bias force on the building member, such that the clip and the accessory will remain substantially in place until removed by a user; wherein at least one clip side portion comprises at least one installation tool engagement structure; an installation tool configured to reversibly engage the clip, the installation tool comprising a tool base portion from which extend tool side portions; wherein at least one tool side portion comprises a receiving structure configured to receive the at least one installation tool engagement structure on the at least one clip side portion; and wherein the installation tool further comprises a mounting point configured for mounting the installation tool on a reach-extending device.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 shows a perspective view of an embodiment of a clip and installation tool of the present invention.

FIG. 2 shows a side view of an embodiment of a clip and installation tool of the present invention, wherein the installation tool is mounted on a reach-extending handle.

FIG. 3 shows a side view of an embodiment of a clip and installation tool of the present invention, where the clip and light string are engaged by the installation tool, in preparation for placement on a building facia.

FIG. 4 shows a side view of an embodiment of a clip and installation tool of the present invention, where the clip is engaged in the installation tool and the clip and light string have been positioned on a building facia.

FIG. 5 depicts an example of a person making use of an embodiment of the present invention to install a light string on a building facia.

FIG. 6 depicts a light string held in place on a building facia with an embodiment of a clip of the present invention, after disengagement from the installation tool.

### DETAILED DESCRIPTION

The following discussion provides many exemplary embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

With respect to all the figures and descriptions provided herein, it should be noted that any references to dimensions are made solely for illustrative purposes only. Such references are not intended to limit the scope of the invention with respect to size, scale, or shape.

Embodiments of the present invention comprise two major components. As shown in the accompanying figures, in some embodiments there is provided is a clip 10, configured to engage a structure on a building, for example a facia 90. The clip 10 is also adaptable to be able to be secured to other building structures such as rafter tails, gutters and other similar architectural features of buildings. The clip 10 is further configured to be able to engage a wire of a decorative light string 80, and to be reversibly clipped into place at a desired location on a building.

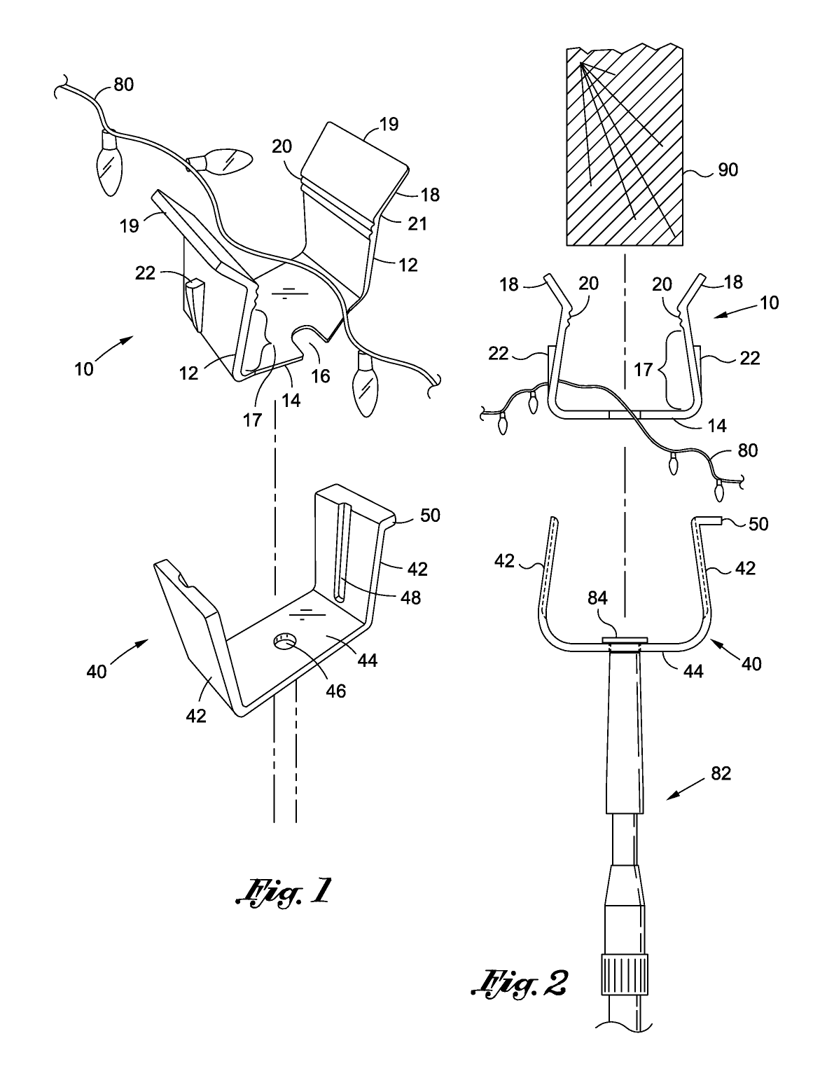

As shown in FIGS. 1 and 2, in some embodiments the clip 10 can be generally shaped as a squared off U-shaped design adapted to fit on whatever structure the user intends the clip and lighting string. It will be apparent that depending on the type of structure one wishes to install the clip, the precise size and shape of the clip may be altered in order to accommodate the dimensions of the structure onto which the clip is intended to be placed.

The clip 10 generally comprises side portions 12 and base portion 14, the side portions extending generally upwards on either side of the base portion 12. In some embodiments, and as shown in FIGS. 1-4, and 6, the lower part of each side portion 17 can be configured to flare generally inward. Conveniently, the clip can be fashioned from a resilient, flexible material that can be bent by an applied force but which is capable of returning substantially to its original form when the applied force is released. A variety of materials are well known to those of skill in the art including various metals with spring like properties, flexible, resilient plastics and the like. In some embodiments, the clip may even be fashioned from a material such as a memory material.

In some embodiments, the clip 10 also can further comprise a notch 16 that is configured to engage a light string. In some cases, the portion of the light string to be engaged will be an end comprising an electrical plug. The notch is especially well adapted to simply engage an electrical plug thus maintaining the light string in position on the clip when commencing an installation. Thus, the notch securely, yet reversibly, holds the light string end so that the light string will not generally slide with respect to clips during installation, or once installed. Engaging a plug end also provides the advantage of permitting a user to place the light string under a moderate amount of tension while installing, so that the tendency of the wiring between lights to sag is reduced. Conversely, where it is desired to allow the light string to droop in order to achieve a wave-like appearance, the tension on the string and spacing of the clips can be varied in order to achieve that desired effect as well.

The present invention is not limited, however, to the installation of light strings. It will be obvious to those of skill in the art that any elongate structure can be readily installed on a building facia using embodiments of the present invention. For example, and without being limiting, banners, signs, bunting and other similar objects could be secured to a building using the devices and methods as described herein.

The clip can include other features intended to make installation easier for the user, and to improve the ability of the clip 10 to maintain a light string in s desired location. For example, in some embodiments, upper clip portions 18 can be designed to flare generally outward with respect to the lower clip portions 12, the transition between lower clip portion 12 and upper clip portion 18 forming a bend point 21. Thus, in some embodiments, the lower clip portion will generally flare inwards towards a vertical axis of the clip, while the upper clip portions 18 will generally flare inwards with respect to that same axis.

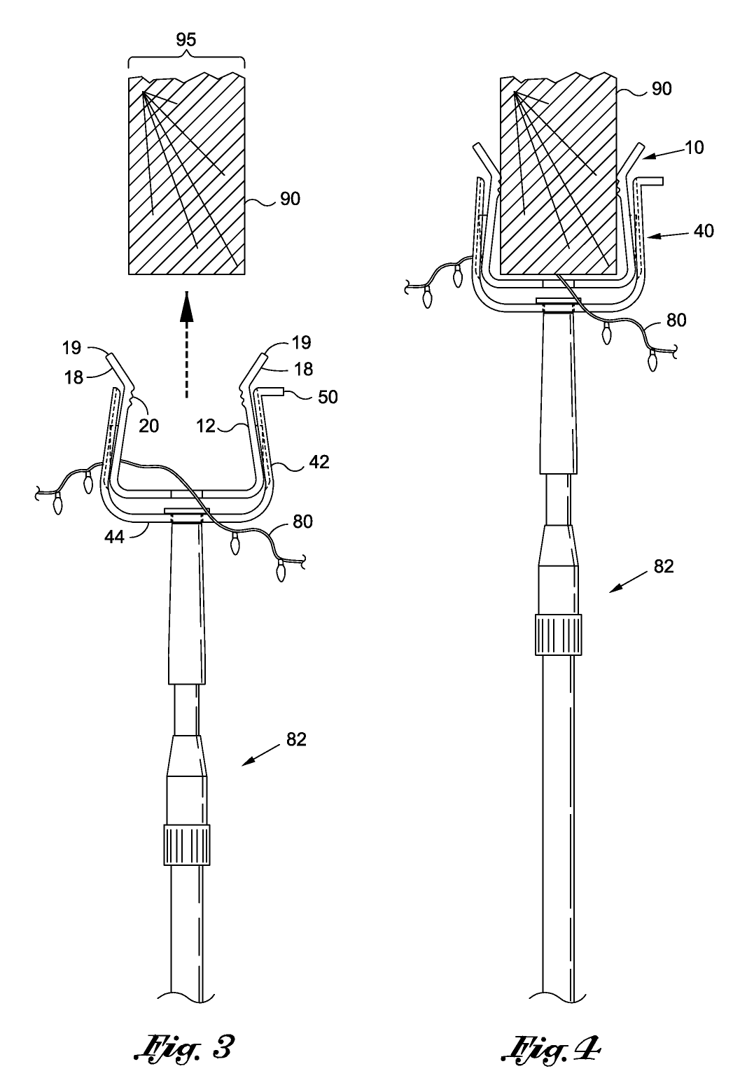

As can be readily appreciated, this configuration provides several advantages with respect to the positioning, installation and retention of the clip 10 in a desired location, for example engaging a portion of a building facia 90. For example, the spacing between the tips 19 can be selected to be wider that the width of the structure onto which the clip is to be installed. As shown in an embodiment depicted in FIG. 3, the spacing between tips 19 can be conveniently be made wider than the width 95 of the facia 90 onto which the clip will be installed. This spacing will enable to user to easily engage the facia 90 during the installation process.

In addition, the angled configuration of the upper clip portion 18 can conveniently function such that when a force is applied to the clip in a generally vertical direction, the force will be converted into a lateral bias force that will be effective to force the tips 19 further apart. Once this bias force increases the spacing between the tips 19 to be substantially similar to, or greater than, the width 95 on the facia, the user will be able to readily continue sliding the clip upwards in order to fully engage the clip. This can be readily appreciated by comparing FIGS. 3 and 4. It should be noted that the illustrations provide an example of a preferred embodiment of the present invention. However, various configurations of the present invention will be apparent to those of skill in the art in order to install clips and lighting on structures other than those depicted, and thus, the invention is not intended to be limited to the specific embodiments depicted herein.

Similarly, and as shown in the drawings, in order to provide better securing of the clip once installed in place, embodiments of the clip may comprise a friction surface 20. The way in which the friction surface 20 operates will be readily understood by those of skill in the art, and can comprise any surface or structure that is effective to prevent the clip from slipping from the location onto which it was been installed. In the illustrated embodiments, the friction surface 20 is depicted as a series of ridges formed in the inner aspect of the lower side portions of the clip. A friction surface 20 may also include adhesive materials, textured surfaces, and other such materials methods known in the art to resist slippage of adjacent surfaces.

The present invention also provides a convenient installation tool 40, designed for use in conjunction with the clip 20. As shown in FIGS. 1-4, an installation tool 40 can comprise a tool base portion 44, from which extend tool side portions 42. The tool side portions 42 extend generally vertically from the tool base portion 44, and generally perpendicular to the plane of the tool base portion 44. In some embodiments, as depicted in the accompanying figures, the tool side portions 42 can be angled inwardly. Such a configuration can be effective to better grip the clip 10 when the clip is engaged in the installation tool, for exampled as depicted in the embodiment shown in FIG. 3. In other embodiments, the tool side portions 42 may extend generally vertically from the tool base portion 44. The precise configuration of the tool is not limiting to the scope of the invention, and all such configurations capable of engaging the clip are intended to be within the scope of the invention.

In either case, the clip 10 and tool base portion may further comprise additional features that improve the ability of the installation tool 40 to retain the clip 10 until such time as the user desires to release the clip 10 from the installation tool 40. In some embodiments these might be hook-like structures, or flanges, or threaded portions. In one embodiment, as depicted in the accompanying drawings, engagement structures can comprise a fin 22 and complimentary groove 48. In some embodiments a fin 22 located on the outer aspect of at least one clip side portion 12, engages and is reversibly slidable into a complimentary groove 48, located on the inner aspect of an installation tool side portion 42. In this way, the fin and groove serve to limit movement of the clip within the installation tool. This conveniently reduces the chances of the clip inadvertently slipping from the tool while in use.

In some embodiments, fins can be generally of similar size and placement located diametrically from each other on adjacent clip side portions. However, the precise shape and placement of each fin 22 or other similar engaging structure is not considered to be limiting and any such placement that is effective to allow a clip 10 to be engaged by an installation tool 40 are considered to be within the scope of the invention.

The base portion 44 of the installation tool also comprises a mounting point 46. The mounting point 46 provides means with which to attach the installation tool 40 to a handle 82 or other reaching extending device. In some embodiments an installation tool 40 can be secured to a handle 82 with a fastener 84. In some embodiments the fastener may comprise a nut and washer combination to allow the installation tool 40 to be reversibly connected to a handle 82. In other embodiments the fastener 84 may comprise a rivet or other permanent attachment structure. Still other embodiments may provide a threaded structure on the tool that can be screwed onto a complementary threaded receiving end on a handle, much like the manner in which a shop broom head can be secured to a broom handle. Such combinations are well known in the art, for example the handle and broom head combination described in U.S. Pat. No. 4,003,668 (Bruso et al.), the entirety of which is hereby incorporated by reference. Thus, the choice of means for securing the installation tool to the handle 84 is not considered to be limiting to the scope of the invention.

The present invention also includes a method for installing a light string 80 or other accessory onto a building structure. Following the figures, one can easily appreciate the steps of the method. For example, one embodiment of the method comprises providing a clip 10 and installation tool 40 as depicted in FIG. 1. One will note, and as shown in FIG. 2, that in some embodiments a light string 80 can be placed into the clip such that the electrical wiring is passed between clip side portions and through the notch 16.

Next, and as shown in FIG. 4, the clip and light string can be engaged in the installation tool 40, and then the clip and light string moved into position on a building facia, as shown in FIG. 4. By pushing generally upwards on the handle 82, a user can apply a force to the clip that will translate into a bias force that will cause the clip side portions 12 and clip upper portions 18 to flex apart and engage the building structure, for example a facia 90. FIG. 4 depicts the clip being moved upwards to substantially fully engage the facia. Friction surfaces 22 engage the facia 90 and resist the tendency of the clip to move once in place, thus securing the light string in the desired position.

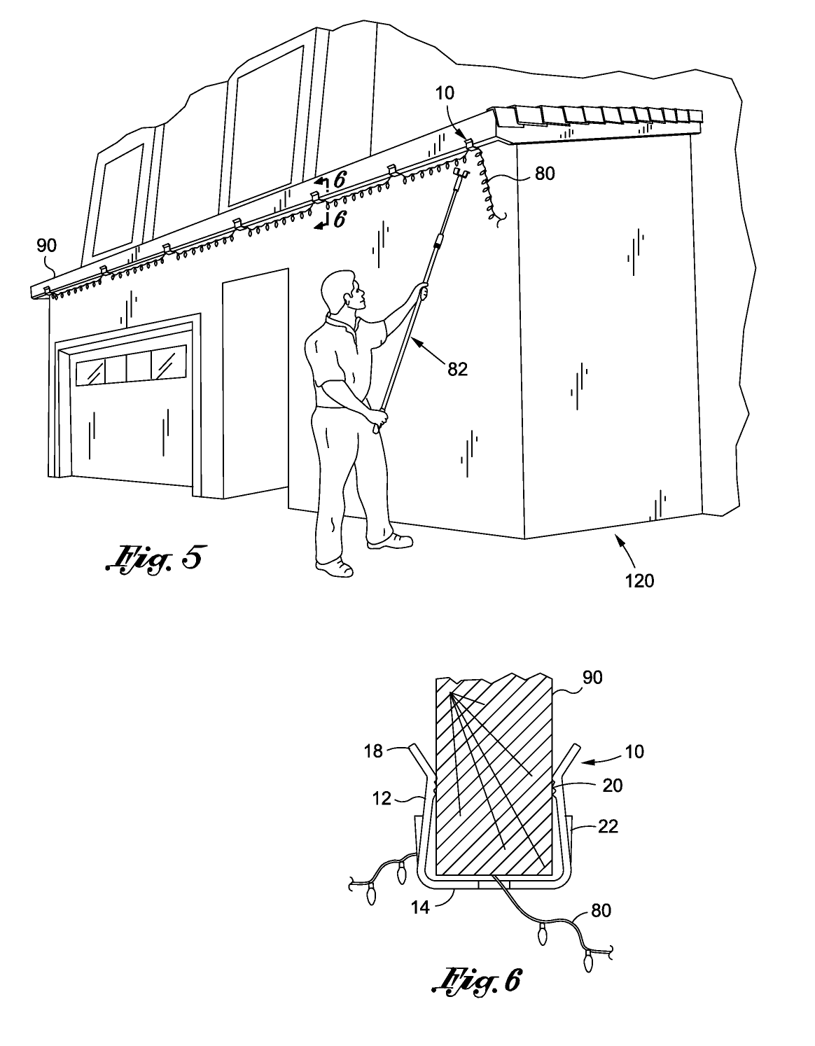

FIG. 5 provides a view of a user employing an embodiment of the clip and tool combination in the present method to sequentially install a light string held in place on a building facia by clips. Finally, FIG. 6 depicts an embodiment of a clip of the present invention as it might appear once installed with a light string held in position.

The handle can be selected to extend the reach of the user so that when installing a light string, the user can avoid having to climb up and down ladders. The present invention also provides the advantage that the clip and light string placed into the clip can be installed remotely by simply reversing the steps used to install the clip in the first instance. The clip provides a further advantage in that it can be reversibly mounted on the building feature, so that when desired, the light string can be taken down, the clips removed, and the building restored to its original undecorated state. The present invention provides a further improvement over prior art devices as the clip does not penetrate the building structure as would a screw or other fastener, and thus no damage is caused by its use.

The installation tool 40 can be further configured to be flexible such that once the clip 10 and light string 80 are in place, the clip can be released by simply twisting the handle 82. In one embodiment, twisting the handle will impart a rotational force on the installation tool. As the clip is secured to the facia, as shown in the depicted embodiments, the clip will be unable to flex to any appreciable degree since any rotational force will be resisted by the facia 90. The net effect is that the rotational force will cause the installation tool side portions 42 to flex, and the fins 22 to be released from the grooves 48. Application of sufficient force will thus result in the clip being completely released from the tool while leaving the clip in place.

Using the system and method of the present invention, an installer can rapidly install or remove decorative in significantly less time than with previous systems and methods, and can do so safely without having to ascend and descend a ladder. Further, since the installation tool is separate from the clip, the clip will require less material to manufacture than other systems where the clip includes a means of attachment to a reach-extending device. Thus, the present system should be significantly more economical to manufacture, as one tool will be useable with multiple clips.

It will be obvious to those of skill in the art that there are various ways and designs with which to produce the apparatus and methods of the present invention. The illustrated embodiments are therefore not intended to limit the scope of the invention, but to provide examples of the apparatus and method to enable those of skill in the art to appreciate the inventive concept.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A system for installing an accessory on a structure, the system comprising:
a clip configured to be reversibly installable on a building member, the clip comprising a clip base portion and clip side portions, the clip side portions extending generally upwards from the clip base portion;
wherein, when installed in a desired location, the clip side portions are configured to exert a bias force on the building member, such that the clip and the accessory will remain substantially in place until removed by a user;
wherein at least one clip side portion comprises at least one installation tool engagement structure;
an installation tool configured to reversibly engage the clip, the installation tool comprising a tool base portion from which extend tool side portions;
wherein at least one tool side portion comprises a receiving structure configured to receive the at least one installation tool engagement structure on the at least one clip side portion; and
wherein the installation tool further comprises a mounting point configured for mounting the installation tool on a reach-extending device.

2. The system of claim 1, wherein the clip further comprises a notch, the notch configured to receive the accessory.

3. The system of claim 1, wherein the installation tool engagement structure comprises a fin and the receiving structure comprises a groove.

4. The system of claim 1, wherein the clip further comprises at least one friction surface, the at least one friction surface effective to maintain the clip in place after installation in the desired location.

5. The system of claim 1, wherein a clip side portion further comprises a lower clip side portion and an upper clip side portion, wherein the lower clip side portion extends inwards, and the upper clip side portion extends outwards, relative to a central vertical axis of the clip.

6. The system of claim 1, wherein the clip further comprises side portion tips, the side portions tips spaced apart a distance greater than a width of the building member on which the clip is to be installed.

7. The system of claim 1, wherein the accessory to be installed on the structure is at least one of a lighting string, a banner, a flag and an electrical cord.

8. The system of claim 1, wherein the building member is at least one of a facia, gutter, and a rafter tail.

9. A method for installing an accessory on a structure, the method comprising:
providing a clip configured to be reversibly installable on a building member, the clip comprising a clip base portion and clip side portions, the clip side portions extending generally upwards from the clip base portion;
wherein, when installed in a desired location, the clip side portions are configured to exert a bias force on the building member, such that the clip and the accessory will remain substantially in place until removed by a user;
wherein at least one clip side portion comprises at least one installation tool engagement structure;
providing an installation tool configured to reversibly engage the clip, the installation tool comprising a tool base portion from which extend tool side portions;
wherein at least one tool side portion comprises a receiving structure configured to receive the at least one installation tool engagement structure on the at least one clip side portion; and
wherein the installation tool further comprises a mounting point configured for mounting the installation tool on a reach-extending device;
providing a reach-extending device, and mounting the installation tool on said device;
engaging the accessory in the clip;
engaging the clip with accessory into the installation tool;
placing the clip and accessory at a location on the building member;
applying a generally vertical force to the reach-extending device sufficient to position the installation tool, clip and accessory into a desired position on the building member;
once the clip and accessory are in the desired position, applied a generally rotational force to the reach-extending device, the rotational force effective to disengage the clip from the installation tool.

10. The method of claim 9, wherein the clip further comprises a notch, the notch configured to receive the accessory.

11. The method of claim 9, wherein the installation tool engagement structure comprises a fin and the receiving structure comprises a groove.

12. The method of claim 9, wherein the clip further comprises at least one friction surface, the at least one friction surface effective to maintain the clip in place after installation in the desired location.

13. The method of claim 9, wherein a clip side portion further comprises a lower clip side portion and an upper clip side portion, wherein the lower clip side portion extends inwards, and the upper clip side portion extends outwards, relative to a central vertical axis of the clip.

14. The method of claim 9, wherein the clip further comprises side portion tips, the side portions tips spaced apart a distance greater than a width of the building member on which the clip is to be installed.

15. The method of claim 9, wherein the accessory to be installed on the structure is at least one of a lighting string, a banner, a flag and an electrical cord.

16. The method of claim 9, wherein the building member is at least one of a facia, gutter, and a rafter tail.

17. A means for installing an accessory on a building member, the means comprising:
a clip configured to be reversibly installable on a building member, the clip comprising a clip base portion and clip side portions, the clip side portions extending generally upwards from the clip base portion;
wherein, when installed in a desired location, the clip side portions are configured to exert a bias force on the building member, such that the clip and the accessory will remain substantially in place until removed by a user;
wherein at least one clip side portion comprises at least one installation tool engagement structure;
an installation tool configured to reversibly engage the clip, the installation tool comprising a tool base portion from which extend tool side portions;
wherein at least one tool side portion comprises a receiving structure configured to receive the at least one installation tool engagement structure on the at least one clip side portion; and
wherein the installation tool further comprises a mounting point configured for mounting the installation tool on a reach-extending device.
